(19) United States
(12) Patent Application Publication
(10) Pub. No.: US 2007/0291218 A1
(43) Pub. Date: Dec. 20, 2007

(54) LCD panel and method for manufacturing the same

(75) Inventors: Chu-Min Chuang, Hsin-Chu (TW); Chih-Jui Pan, Hsin-Chu (TW); Shigeo Fuse, Hsin-Chu (TW)

Correspondence Address: BACON & THOMAS, PLLC, 625 SLATERS LANE, FOURTH FLOOR, ALEXANDRIA, VA, 22314, US

(73) Assignee: AU Optronics Corp., Hsin-Chu (TW)

(21) Appl. No.: 11/727,431

(22) Filed: Mar. 27, 2007

(30) Foreign Application Priority Data
Jun. 19, 2006 (TW) 095121849

(51) Int. Cl. G02F 1/13

(52) U.S. Cl. 349/187

(57) ABSTRACT

A method for manufacturing a liquid crystal display (LCD) panel, which uses an inkjet process to locate the spacers adjacent the protrusions to uniform the thickness of the liquid crystal layer. The spacers are located in the regions which are under/above the black matrix or the metal lines. Accordingly, the light leakage caused by the spacers is not present in the pixel region. Thus, an inventive LCD device can avoid the problem of light leakage generated by the pixel region of an LCD device with the conventional scattered spacers, and provide a high-contrast display quality. Further, the cost for manufacturing LCD devices can be effectively reduced, and the requirement of large-sized panel development can be met.

### BACKGROUND OF THE INVENTION

1. Field of the Invention

The invention relates to a liquid crystal display (LCD) device and the manufacturing method thereof, and more particularly, to a vertical-alignment (VA) type, a twisted-nematic(TN) type, an in-plane-switch (IPS) type, or an optically compensated birefringence (OCB) type LCD panel and the manufacturing method thereof.

2. Description of Related Art

Current LCD devices, as compared to conventional Cathode Ray Tube (CRT) monitors, have the advantages of low power consumption, small volume and non-radiation. Because the LCD devices are following the large-sized, high-illuminance, high-contrast ratio and wide-viewing requirements, the LCD development is shifting from TN LCD devices, which have the viewing angle restriction, to wide-viewing LCD devices.

Typically, the spacers used in the current LCD devices are grouped into a scattered spacer and a photo spacer, which can uniform the thickness of a liquid crystal layer. However, LCD devices mostly use a scattering process to form the spacers in the panels, which scatters the spacers over the pixel region and results in the light leakage and the increased dark illuminance. Thus, the contrast ratio is reduced. In addition, the scattering process can easily cause process defects, such as spacer gather or a scrape on an aligned film.

As shown in FIG. 1a, the scattered spacers can be formed by a wet process, which scatters the spacers in a spacer dispersion solution and uses a sprayer to sparge the solution over a substrate surface to form the drops A. Due to no bump existing on the substrate surface, even when each distance X between the drops A is accurately controlled, the spacers 1 in each drop A cannot be positioned accurately.

As shown in FIGS. 1a to 1c, the solvent contained in the drops A is vaporized and dried within the elapsed time, and the spacers 1 in each drop A are gathered as a pile and remain alone on the substrate surface. In this case, the distance X between the drops A cannot be kept as shown in FIG. 1c in which the distances X₁, X₂ between the piles of spacers 1 depart from that of the original design. Accordingly, the spacers located in the pixel region cause the light leakage. FIG. 3 is a schematic top-view of the solvent contained in the drops A of FIGS. 1a to 1c and vaporized within the elapsed time. As shown in FIG. 3, the spacers 1 in each drop A are gathered gradually with the solvent on vaporizing, and the finally gathered position of the spacers 1 cannot be predicted.

The photo spacers can avoid the light leakage caused by the conventional scattered spacers in the pixel region, but current processes cannot form the photo spacers in a panel at a same height, especially a large-sized panel. Thus, the amount of liquid crystals is not easily controlled. As compared to the LCD devices with the scattered spacers, the LCD devices with the photo spacers require an additional mask and a height checker for the photo spacers to thereby measure the heights of the photo spacers and accurately control the drop amount of liquid crystals. Therefore, the processing cost for the LCD devices with the photo spacers is quite high.

As stated, an improved LCD panel is required, which can meet with the wide-viewing requirement without the light leakage caused by the LCD devices with the scattered spacers and effectively reduce the processing cost to thereby increase the product competition on marketing.

### SUMMARY OF THE INVENTION

The object of the invention is to provide a method for manufacturing a substrate of a liquid crystal display panel, which can be used in a liquid crystal display, including VA, TN, IPS and OCB LCD devices.

The invention provides a method for manufacturing a liquid crystal display (LCD) panel, which locates the spacers adjacent the protrusions to uniform the thickness of the LC layer. The spacers are located in the regions where they are under/above the black matrix and the metal lines. Accordingly, the light leakage caused by the spacers is not present in the pixel region such that an LCD device with the LCD panel has the features of high contrast and wide viewing angle. Thus, the requirement of developing a satisfactory large-sized panel is met.

The invention provides a liquid crystal display (LCD) panel, which comprises a first substrate, a second substrate, a plurality of metal lines, a protrusion, a plurality of spacers, and a liquid crystal (LC) layer. The first substrate has a first surface. The second substrate has a second surface facing the first surface of the first substrate. The metal lines are formed on the first surface. The protrusion is formed on the second surface and corresponds to one of the metal lines, and the spacers neighbor with the protrusion on the second surface. The LC layer is interposed between the first and second substrates. Thus, the spacers in the LCD panel can avoid the light leakage in the pixel region and increase the contrast on the LCD device.

The invention provides a method for manufacturing a substrate used in a liquid crystal display (LCD) panel, which comprises: providing the substrate having a surface on which a protrusion is located; dripping at least one drop to the protrusion, wherein the at least one drop contains a solvent and plural spacers; and removing the solvent so that the spacers are adjacent to the protrusion. Accordingly, the method can enable manufacture of the upper substrate of the LCD device, and avoid the light leakage occurring in an LCD device with the conventional scattered spacers. In addition, as compared to an LCD device with the photo spacers, the method can effectively reduce the manufacturing cost and simplify the processing steps.

In the method for manufacturing a substrate used in a liquid crystal display (LCD) panel, the substrate can be a color filter substrate or a thin-film transistor (TFT) substrate, and the TFT substrate is preferred.

An embodiment of the method for manufacturing a liquid crystal display (LCD) panel is provided as follows, but is not limited to this.

In this embodiment, the method for manufacturing a liquid crystal display panel comprises: (a) Providing a first substrate having a surface on which a protrusion and plural spacers are located; (b) Providing a second substrate to, sandwich a liquid crystal layer between the first and second substrates. (c) Dripping at least one drop to the protrusion, wherein the spacers are dispersed in a solvent. (d) Removing the solvent so that the spacers neighbor with the protrusion.

In the method for manufacturing a liquid crystal display (LCD) panel, the first substrate and the second substrate can be a color filter (CF) substrate and/or a TFT substrate. Preferably, the first substrate is the CF substrate, and the second substrate is the TFT substrate. In this case, the first substrate has a color filter layer, and the second substrate has a TFT, a transparent region, or the combination thereof. An opaque region is preferred to be a metal line corresponding to the protrusion.

When the first substrate and the second substrate are assembled, the spacers are located in a region which is under/above the TFT, opaque region or combination of the second substrate. Accordingly, an LCD device with the panel manufactured by the method can avoid the light leakage in the pixel region and increase the contrast. As compared to an LCD device with the photo spacers, the method can effectively reduce the manufacturing cost and simplify the processing steps, thereby increasing the product competition on marketing.

In the methods, the dripping process used by a spacer dispersion solution in the invention can be any process that can drip the solution to the substrate surface, but an inkjet process is preferred. In addition, the spacers are not under/above each other. Accordingly, the method can control the spacer dispersion solution to be located over the positions at the surroundings of the protrusions on the substrate surface, thereby avoiding the pixel region, which has the scattered spacers, of the substrate from light leakage.

In addition, in the method, a sealant layer is formed around the first or the second substrate for a next process of dripping the liquid crystals to a substrate surface.

In an embodiment, the method for manufacturing a liquid crystal display (LCD) panel comprises forming a sealant layer around a first substrate and filling liquid crystals to a surface of the first substrate. Thus, the liquid crystal filling process for an LCD device of the invention is complete. Alternatively, the liquid crystal filling process can be applied to a surface of the second substrate while a sealant layer around the second substrate is first formed.

The liquid crystal filling process in the invention can be any liquid crystal filling process suitable for an LCD panel, but a one drop filling (ODF) process is preferred. The sealant layer can be of any sealing material, but a UV cure adhesive is preferred. The UV cure adhesive can be hardened by UV illumination.

The LCD panel further comprises a black matrix to increase the contrast ratio and prevent color materials from being color-mixed. The black matrix preferably locates at the first substrate immediately adjacent to a color filter. Alternatively, the black matrix can locate at the second substrate.

In an embodiment, when the first and the second substrates are assembled, the black matrix locates at the first substrate and overlaps the TFT or metal lines of the second substrate to thereby eliminate the light leakage at the TFT or metal lines.

In addition, the metal lines can be plural scan lines, data lines, auxiliary capacitor lines or combinations thereof. The spacers can be located in the regions which are under/above the regions of the scan lines, data lines or auxiliary capacitor lines so as not to cause the light leakage in the pixel region. In an embodiment, the spacers are located in the regions which are under/above the scan lines and TFT of the second substrate to thereby prevent the light leakage that is present in the LCD devices with the scattered spacers.

In the LCD device, the spacers can be of any shape, but a spherical shape is preferred for advantageously locating the spacers to the surroundings of a protrusion. The protrusions can be any shape, but a linear, V-, Y- or irregular shape is preferred. The protrusions can be a bump or an extended strip, for example. In addition, the spacers are preferably colored spacers in order not to influence the contrast of the LCD device on a dark display, and more preferably black spacers are used.

In the LCD panel, the spacers can be of any material, but a resin material is preferred. In addition, the spacers with a surface modification layer are preferred. Accordingly, the shapes of the spacers do not influence the arrangement directions of the LC molecules around the spacers so as to avoid the light leakage. The surface modification layer can have a long-carbon-chain group, and a silane coupling agent is preferred. Accordingly, the shape of the spacers does not influence the arrangement direction of the LC particles so as to enhance the contrast of an LCD with the LCD panel.

In addition, the LCD panel and the method for manufacturing the same can be applied to any LCD device, but a VA, TN, IPS or OCB LCD device is preferred. In the invention, the second substrate further comprises a transparent electrode layer with plural slits to thereby widen the viewing angle of the LCD panel and increase the viewing effect on an LCD with the LCD panel. Therefore, the LCD can have the high-contrast and wide-viewing feature, which can meet with the requirement of developing large-sized panels.

Other objects, advantages, and novel features of the invention will become more apparent from the following detailed description when taken in conjunction with the accompanying drawings.

### BRIEF DESCRIPTION OF THE DRAWINGS

FIGS. 1a to 1c are schematically cross-sectional views of a solvent contained in the drops of a spacer dispersion solution on a conventional substrate surface on which there is no protrusion and vaporized within the elapsed time;

FIGS. 2a to 2c are schematically cross-sectional views of a solvent contained in the drops of a spacer dispersion solution on a substrate surface on which there are protrusions and vaporized within the elapsed time according to an embodiment of the invention;

FIG. 3 is a schematic top-view of a solvent contained in the drops A of FIGS. 1a to 1c and vaporized within the elapsed time;

FIGS. 4a and 4b are schematic top-views of a solvent contained in the drops A of FIGS. 2a to 2c and vaporized within the elapsed time according to the invention;

FIG. 5 is a top view of an upper substrate for an LCD device according to an embodiment of the invention;

FIG. 6 is a top view of a lower substrate for an LCD device according to an embodiment of the invention;

FIG. 7 is a top view of an upper substrate for an LCD device according to another embodiment of the invention;

FIG. 8 is a top view of an upper substrate for an LCD device according to a further embodiment of the invention;

FIG. 9 is a top view of a lower substrate for an LCD device according to another embodiment of the invention;

FIG. 10 is a top view of an upper substrate for an LCD device according to another further embodiment of the invention; and

FIG. 11 is a top view of a lower substrate for an LCD device according to a further embodiment of the invention.

### DETAILED DESCRIPTION OF THE EMBODIMENT

### Embodiment 1

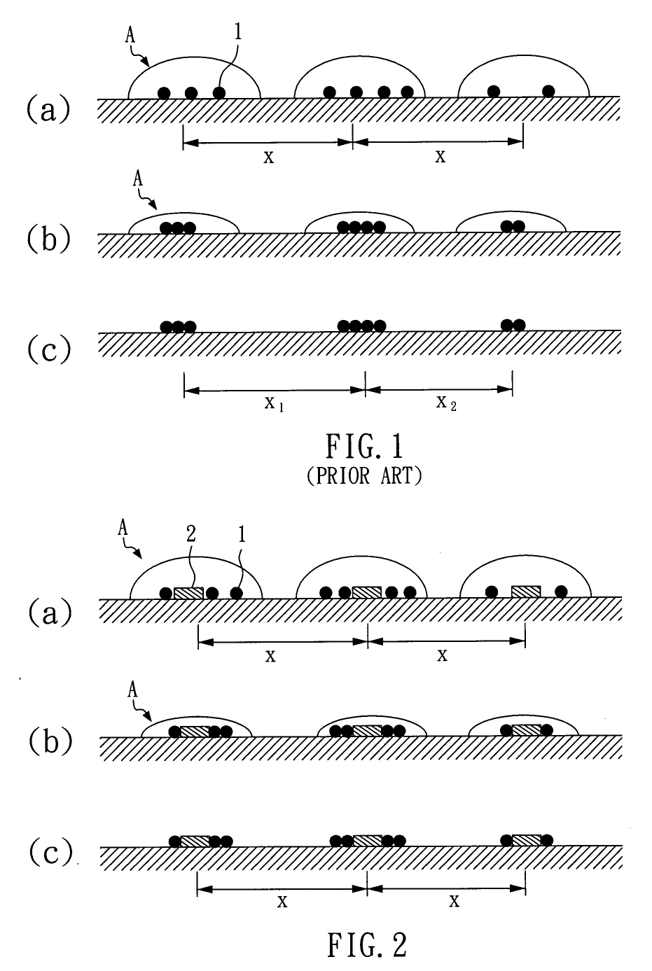

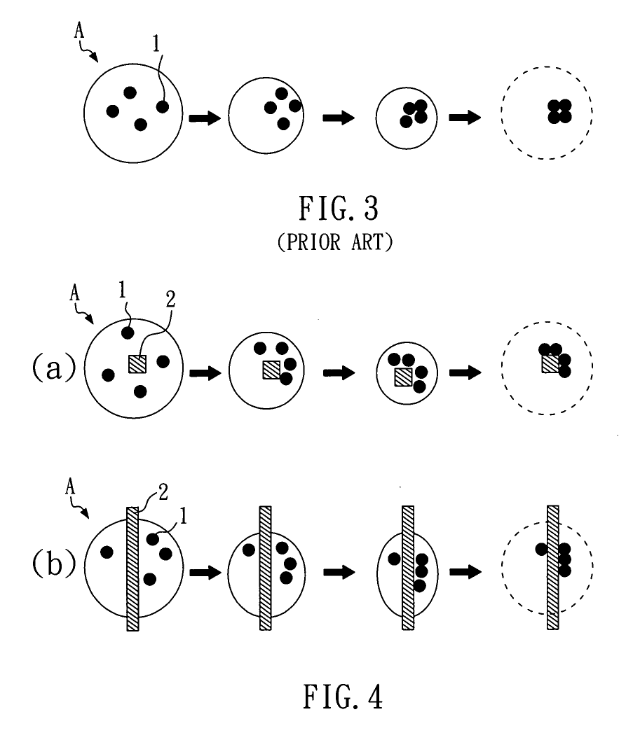

FIGS. 2a to 2c are schematically cross-sectional views of a solvent contained in the drops of the spacer dispersion solution on a substrate surface on which there are protrusions and vaporized within the elapsed time according to an embodiment of the invention.

As shown in FIGS. 2a to 2c, the invention uses an inkjet process to locate the drops A adjacent to the protrusions 2 on the substrate surface. As the solvent contained in the drops A is vaporized and dried within the elapsed time, the spacers 1 in each drop A are gathered as a pile adjacent to the protrusions 2. In this case, due to the protrusions 2 on the substrate surface, the distance X remains between the piles of the spacers.

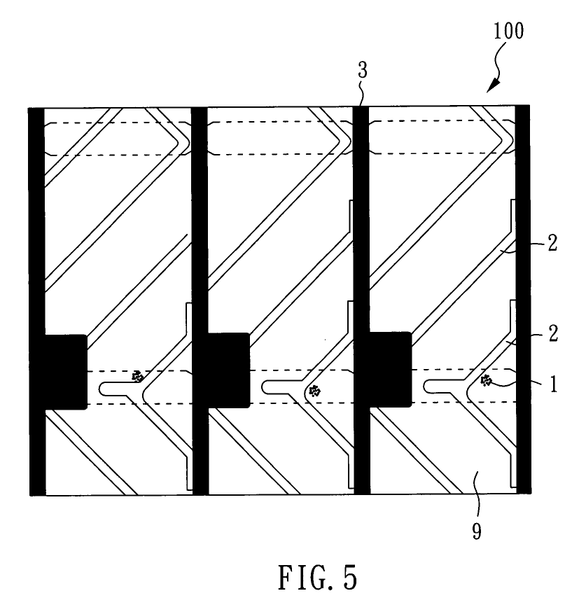

FIGS. 4a and 4b are schematic top-views of the solvent contained in the drops A of FIGS. 2a to 2c and vaporized within the elapsed time. The protrusions in FIGS. 4a and 4b are a dot shape and a bar shape respectively. As shown in FIGS. 4a and 4b, the spacers 1 in each drop A are gathered gradually with the solvent on vaporizing, and the finally gathered position of the spacers 1 can be predicted. Therefore, the invention can accurately control the formed regions of the spacers. After the first and the second substrates are assembled, the invention can arrange the located in the region of the spacers be under/above the TFT or opaque region of the second substrate to thereby prevent the spacers from causing the light leakage in the pixel region.

### Embodiment 2

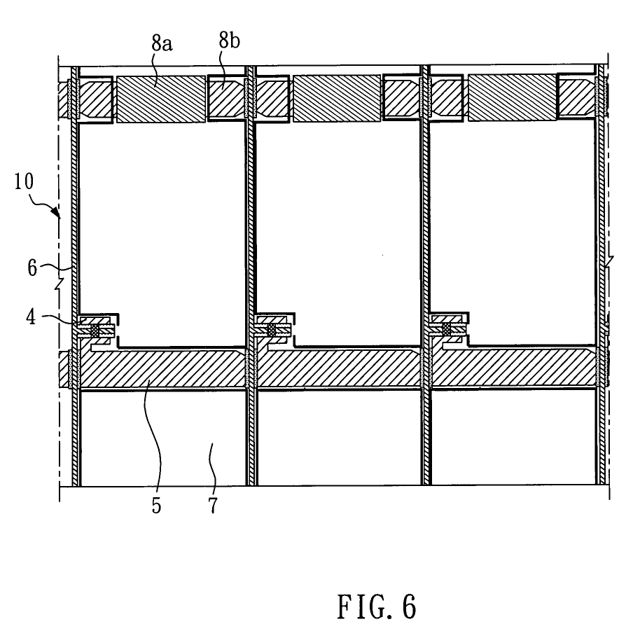

FIG. 5 is a top view of an upper substrate for an LCD device according to an embodiment of the invention. FIG. 6 is a top view of a lower substrate for the LCD 100 of FIG. 5. In this embodiment, the LCD device 100 is a multi-domain vertical alignment (MVA) LCD device.

As shown in FIGS. 5 and 6, the LCD 100 comprises an upper substrate having a color filter 9, plural protrusions 2 and a black matrix 3, and a lower substrate having plural TFTs 4, a transparent electrode layer 7 and plural metal lines 5, 6, 8b. The black matrix 3 is immediately adjacent to the color filter 9. The transparent electrode layer 7 has plural slits (not shown). The shape of the protrusions 2 is a Y- and V-shaped combination. For a top view, only the upper substrate is shown in FIG. 5.

In addition, the upper substrate of the LCD device 100 further comprises plural spherical spacers 1 located adjacent to the protrusions 2. In this embodiment, the spacers 1 are black, and the surface of each spacer has a surface modification layer with a silane coupling agent. Accordingly, the spacers do not influence the contrast of the LCD device on a dark display, and the shapes of the spacers do not influence the arrangement directions of the LC molecules around the spacers. Thus, a good contrast is provided for display.

In the LCD device 100, after the upper substrate and the lower substrate 10 are assembled, the spacers 1 are located in the regions which are under/above the TFTs 4 and metal lines 5 of the lower substrate 10. Accordingly, the spacers 1 in the LCD device 100 are not located in the pixel regions of the lower substrate so as to avoid the light leakage in the pixel regions and increase the contrast on the frame of the LCD 100. It is noted that the spacers in this case can also be located in the regions which are under/above the metal lines 6, 8b, and is not limited to the above description.

When the upper substrate and the lower substrate 10 are assembled, the black matrix just overlaps the TFTs 4 and metal lines 6 of the lower substrate 10 to thereby avoid the TFTs 4 affected by ambient light. Accordingly, the dotted lines shown in FIG. 5 indicate the metal lines 5, 8b (FIG. 6) of the lower substrate 10. As shown in FIG. 6, the metal lines 5 are the scan lines of the TFTs 4, the metal lines 6 are the data lines of the TFTs 4, and the metal lines 8b are the metal lines of the auxiliary capacitors 8a.

However, the black matrix 3 in this case can shade the regions of the TFTs 4 and metal lines 6 of the lower substrate 10 and optionally those of the metal lines 5, 8b, depending on various design choices.

As stated, the LCD device 100 can have the features of high contrast and wide viewing to meet with the requirement of developing a large-sized panel.

The method for manufacturing a panel of the LCD device 100 comprises the steps as follows. The spacer dispersion solution on the substrate surface is vaporized by a process, which is illustrated in FIGS. 2a to 2c of the invention in which the spacers contained in the spacer dispersion solution can be located adjacent to the protrusions.

The method first prepares an upper substrate having a color filter 9, and a lower substrate having plural TFTs 4 and plural metal lines 5, 6, 8b. Next, after the plural protrusions 2 are formed on the surface of the upper substrate, an inkjet process is used to locate a spacer dispersion solution over the protrusions 2. The spacer dispersion solution contains plural spacers and a solvent.

Next, in order to locate the spacers 1 to the surrounding of the protrusions 2, the solvent contained in the spacer dispersion solution on the substrate surface is vaporized. Next, a sealant layer (not shown) is formed around the upper substrate, and the upper substrate with the sealant layer is filled with liquid crystal by a liquid crystal filling process. In this case, the sealant layer is a UV cure adhesive, and the liquid crystal filling process is a one drop filling (ODF) to drip the LCs to the upper substrate.

Finally, the upper and the lower substrates are assembled, and UV illumination is used to harden the sealant layer for sealing the upper and lower substrates and completing the panel of the LCD device 100.

After the assembly of the upper and lower substrate is complete, the spacers of the upper substrate are located just in the regions which are under/above the TFTs 4 and metal lines 6 of the lower substrate 10.

### Embodiment 3

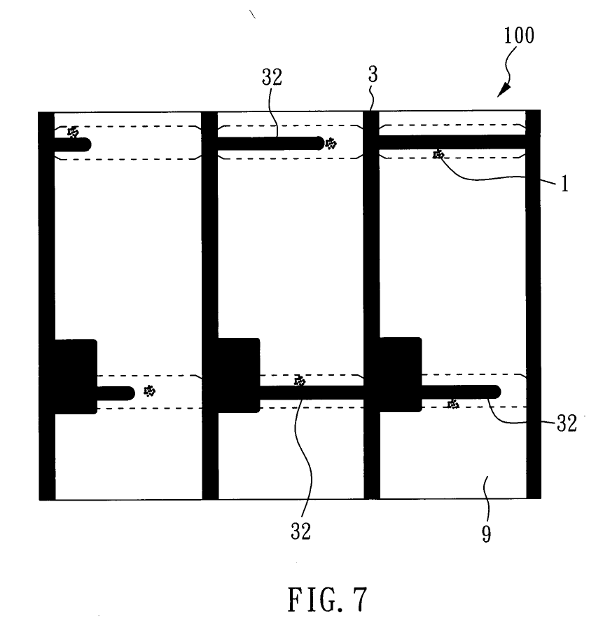

FIG. 7 is a top view of an upper substrate for an LCD device according to another embodiment of the invention. In FIG. 7, the LCD device comprises an upper substrate having a color filter 9 and a black matrix 3, and a lower substrate having plural TFTs 4, a transparent electrode layer 7 and plural metal lines 5, 6, 8b that are identical to those of the first embodiment. In this embodiment, the black matrix 3 is immediately adjacent to the color filter 9. The LCD device in this embodiment is a TN TFT-LCD on which there is no protrusion, as compared with the MVA TFT-LCD shown in the first embodiments. In addition, the black matrix 3 corresponding to the metal lines 5, 8b of the lower substrate of the TN LCD has the extended strips 32. The lengths of the extended strips are changed with the actual needs, which can even connect to another parallel black matrix 3. The metal lines 8b function as the auxiliary capacitors and can selectively have no extended strips 32.

In this embodiment, the upper substrate of the LCD device 100 comprises plural spherical spacers 1 located adjacent to the extended strips 32 of the black matrix 3 of the upper substrate. The spacers 1 can be of a material identical to that of the first embodiment, and correspond only to the metal lines 5, 8b without being located to the pixel regions 7 of the lower substrate, thereby avoiding the light leakage in the pixel regions 7.

Similarly, the method for manufacturing a panel of the LCD device in this embodiment prepares an upper substrate having a color filter 9 and a black matrix 3, and a lower substrate having plural TFTs 4 and plural metal lines 5, 6, 8b. Next, an inkjet process is used to locate a spacer dispersion solution over the extended strips 2. The spacer dispersion solution contains plural spacers and a solvent.

Next, in order to locate the spacers 1 to the surroundings of the extended strips 32 of the black matrix, the solvent contained in the spacer dispersion solution on the substrate surface is vaporized. The following steps are identical to those of the first embodiment. Accordingly, the panel of the TN TFT-LCD device is complete.

### Embodiment 4

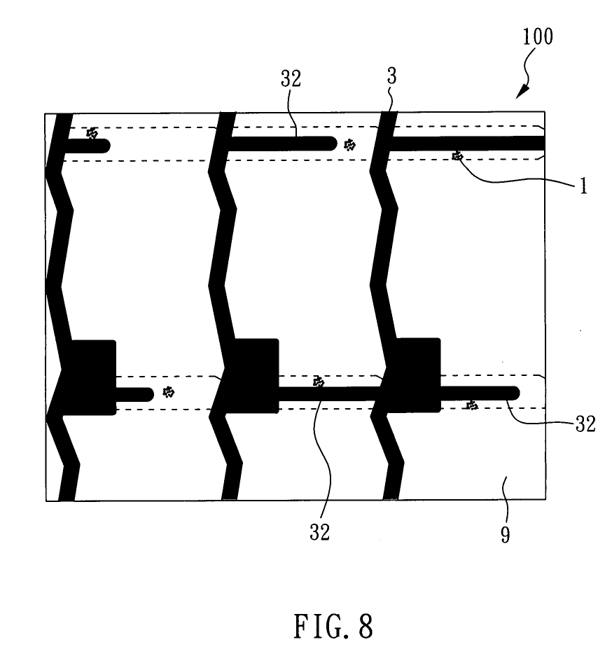

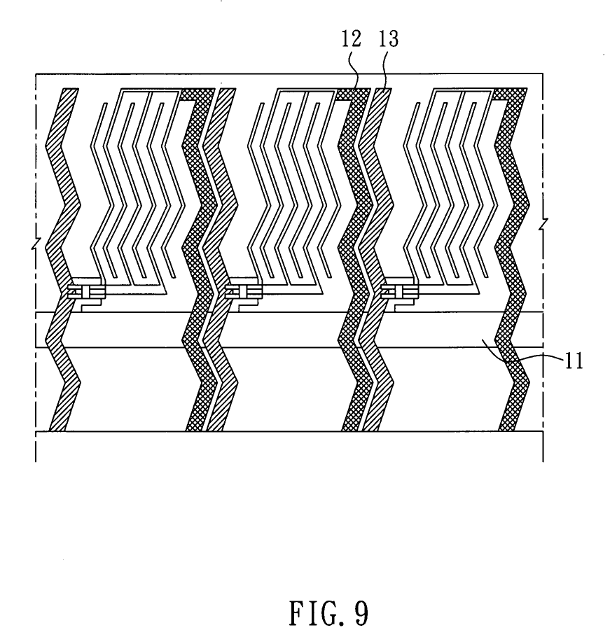

In this embodiment, the spacers and the location thereof are identical to those in the second embodiment except that an IPS LCD device is used. The IPS LCD device has a panel comprising an upper substrate having a color filter 9 and a black matrix 3, as shown in FIG. 8, and with a lower substrate 10 having plural TFTs 4, plural metal lines 11, 12, 13 and a transparent electrode layer (not shown), as shown in FIG. 9, where the metal lines 11 are a gate line, the metal lines 12 are a common line, and the metal lines 13 are a data line. In addition, the panel of the IPS LCD is completed by the method identical to that used in the second embodiment.

### Embodiment 5

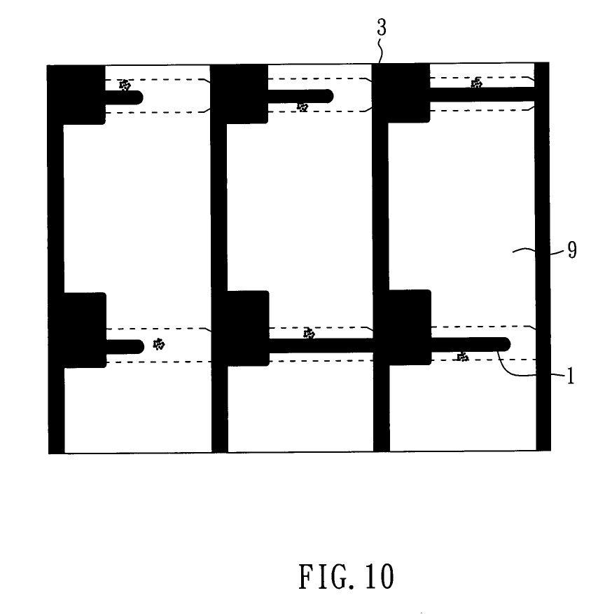

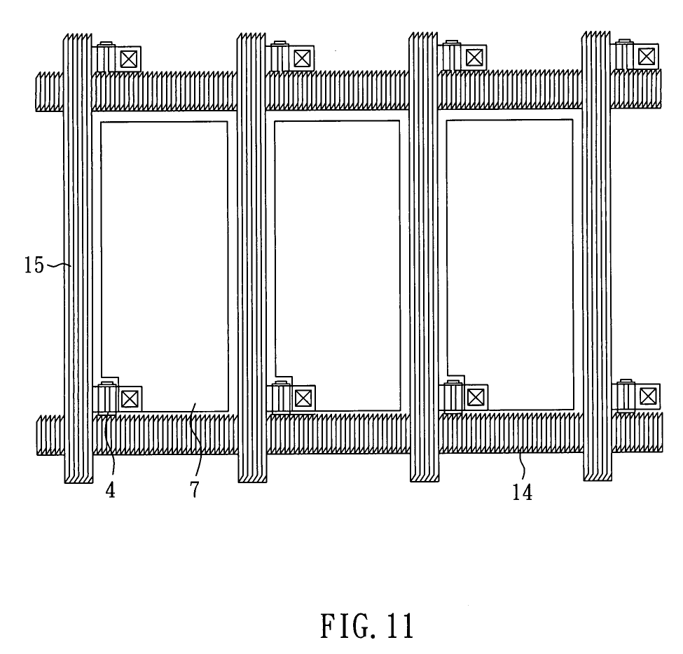

In this embodiment, the spacers and the location thereof are identical to those in the second embodiment except that an OCB LCD device is used. The OCB LCD device has a panel comprising an upper substrate having a color filter 9 and a black matrix 3, as shown in FIG. 10, and with a lower substrate having plural metal lines 14, 15, plural TFTs 4, and a transparent electrode layer 7, as shown in FIG. 11 in which the metal line 14 are a gate line and the metal lines 15 are a source line. In addition, the panel of the OCB LCD is completed by the method identical to that used in the second embodiment.

As stated, the method for manufacturing an LCD panel can effectively reduce the cost and simplify the steps, as compared to an LCD with the photo spacers, to thereby enhance the product competition on marketing. In addition, an LCD with the panel manufactured by the method can avoid the light leakage in an LCD with the conventional scattered spacers to thereby increase the contrast of the LCD.

Although the present invention has been explained in relation to its embodiment, it is to be understood that many other possible modifications and variations can be made without departing from the spirit and scope of the invention as hereinafter claimed.

What is claimed is:

1. A method for manufacturing a substrate of liquid crystal display (LCD) panel, comprising:
providing a substrate having a surface on which a protrusion is located;
dripping at least one drop to the protrusion, wherein the at least one drop contains a solvent and plural spacers; and
removing the solvent so that the spacers neighbor with the protrusion.

2. The method of claim 1, wherein the substrate is a color filter substrate.

3. The method of claim 1, wherein dripping the at least one drop to the protrusion comprises an inkjet process.

4. The method of claim 1, wherein the spacers are non-overlapped with each other.

5. The method of claim 1, wherein the spacers are spherical.

6. The method of claim 1, wherein the protrusion is a bump or an extended strip.

7. A method for manufacturing a liquid crystal display panel, comprising:
providing a first substrate having a surface on which a protrusion and plural spacers are located; and
providing a second substrate to sandwich a liquid crystal layer between the first and second substrates;
dripping at least one drop to the protrusion, wherein the spacers are dispersed in a solvent; and
removing the solvent so that the spacers neighbor with the protrusion.

8. The method of claim 7, wherein the first substrate is a transparent substrate having a color filter.

9. The method of claim 7, wherein dripping the at least one drop to the protrusion comprises an inkjet process.

10. The method of claim 7, wherein the spacers are non-overlapped with each other.

11. The method of claim 7, wherein the spacers are spherical.

12. The method of claim 7, wherein the protrusion is a bump or an extended strip.

13. The method of claim 7, wherein the second substrate is a thin film transistor substrate.

14. The method of claim 7, wherein the second substrate has one or more opaque regions.

15. The method of claim 14, wherein the opaque regions are formed by metal lines.

16. The method of claim 14, wherein each opaque region corresponds to the protrusion.

17. A liquid crystal display (LCD) panel, comprising:
a first substrate having a first surface;
a second substrate having a second surface facing the first surface of the first substrate;
a plurality of metal lines formed on the first surface;
a protrusion, which is formed on the second surface and corresponds to one of the metal lines;
a plurality of spacers, which are formed on the second surface and neighbor with the protrusion; and
a liquid crystal layer interposed between the first and second substrates.

18. The LCD panel of claim 17, wherein the spacers are non-overlapped with each other.

19. The LCD panel of claim 17, wherein the second substrate has a color filter.

20. The LCD panel of claim 17, wherein the protrusion is a bump or an extended strip.
